(19) United States
(12) Patent Application Publication
(10) Pub. No.: US 2026/0336543 A1
(43) Pub. Date: Oct. 29, 2026

(54) MOUNT DEVICE FOR VEHICLE

(71) Applicant: HYUNDAI MOBIS CO., LTD., Seoul (KR)

(72) Inventor: Sun Jong OH, Yongin-si (KR)

(73) Assignee: HYUNDAI MOBIS CO., LTD., Seoul (KR)

(21) Appl. No.: 19/393,933

(22) Filed: Nov. 19, 2025

(30) Foreign Application Priority Data
Apr. 24, 2025 (KR) 10-2025-0053498

(51) Int. Cl. B60R 16/023; B60R 11/00

(52) U.S. Cl. CPC B60R 16/0239; B60R 11/00; B60R 2011/0066

(57) ABSTRACT

A mount device for a vehicle, for fixing a position of an electric component for the vehicle to a vehicle body, including a bolt member having one side fixed to the electric component, and a nut member screw-coupled to the bolt member to be linearly movable from the bolt member.

### CROSS-REFERENCE TO RELATED APPLICATIONS

This application claims the benefit of Korean Patent Application No. 10-2025-0053498, filed on Apr. 24, 2025, which is hereby incorporated by reference as if fully set forth herein.

### TECHNICAL FIELD

The present disclosure relates to a mount device for a vehicle, which has an adjustable length.

### BACKGROUND

As vehicle functions have improved in recent years, a large number of electric components are installed inside the cockpit of a vehicle.

For example, the exterior of an electric component is formed by a housing, and the housing may be fixed in position on a bracket, such as a cowl crossbar and a crash pad, in the cockpit. In this case, when the housing is fixed directly to the bracket with a fastening member like a bolt, the fastened portion may loosen or break due to vibrations generated during driving. Therefore, to deal with vibrations that occur during driving, one side of the housing may be supported on the bracket through a mount device, which allows for movement in a specific direction.

The mount device may be formed in a structure where a metal bar is combined with a rubber cover. For example, the mount device may be formed by shaping the metal bar through cutting, engraving, and polishing by computer numerical control (CNC) machining, and then combining the metal bar and rubber cover by an insert injection molding process.

However, the above method for manufacturing a mount device has problems such as increased manufacturing time and cost and difficulties with mass production due to its complex processing. In addition, the limited length of the mount device makes it difficult to adapt to changes in the internal structure of a vehicle.

### SUMMARY

Accordingly, the present disclosure is directed to a mount device for a vehicle that substantially obviates one or more problems due to limitations and disadvantages of the related art.

Embodiments of the present disclosure may provide a mount device for a vehicle, which is designed to have an adjustable length corresponding to a distance between an electric component and a bracket which are fixed in position.

Embodiments of the present disclosure may provide a mount device for a vehicle, which has a length adjustable adaptively according to a distance between an electric component and a bracket which are fixed in position, and thus may be used commonly in various vehicle types.

Embodiments of the present disclosure may provide a mount device for a vehicle, which has a reduced manufacturing time and cost by eliminating the need for CNC machining.

Embodiments of the present disclosure may provide a mount device for a vehicle, which does not require a separate tool during a manufacturing process and thus reduces a manufacturing time, while enabling mass production.

The objects to be achieved by the present disclosure are not limited to what has been particularly described hereinabove and other objects not described herein will be more clearly understood by persons skilled in the art from the following detailed description.

To achieve these objects and other advantages and in accordance with the purpose of the present disclosure, as embodied and broadly described herein, a mount device for a vehicle, for fixing a position of an electric component for the vehicle to a vehicle body, includes a bolt member having one side fixed to the electric component, and a nut member screw-coupled to the bolt member and configured to be linearly movable from the bolt member.

The bolt member may include: a head portion fixed to the electric component; and a shaft protruding from one side of the head portion to extend outside the electric component, and having a thread formed on an outer circumferential surface thereof.

The nut member may include: a length adjustment portion having a thread formed on an inner circumferential surface thereof and configured to be screw-coupled to the thread formed on the outer circumferential surface of the shaft of the bolt member; and a cover covering an outer circumferential surface of the length adjustment portion.

The length adjustment portion may have a plurality of grooves in a lattice pattern on the outer circumferential surface thereof.

The length adjustment portion and the cover may be configured as a single body by an insert injection molding process.

The mount device may include a stopper for presetting a fixed position of the nut member.

The stopper may surround the outer circumferential surface of the shaft, with a first side of the stopper being in contact with the nut member and a second side of the stopper being in contact with the head portion.

The stopper may have a slit disposed in a longitudinal direction on one side thereof and the stopper may be elastically deformable through the slit.

When the nut member is rotated clockwise or counterclockwise, the nut member may linearly move along a longitudinal direction of the bolt member, and a length of the mount device may be changed.

According to embodiments of the present disclosure, a mount device for a vehicle, for fixing a position of an electric component for the vehicle to a vehicle body, includes: a bolt member having one side fixed to the electric component; a nut member screw-coupled to the bolt member and configured to be linearly movable from the bolt member; and a stopper detachably coupled to the nut member to preset a fixed position of the nut member.

According to embodiments of the present disclosure, a mount device for a vehicle may be provided, which is designed to have an adjustable length corresponding to a distance between an electric component and a bracket which are fixed in position.

According to embodiments of the present disclosure, a mount device for a vehicle may be provided, which has a length adjustable adaptively according to a distance between an electric component and a bracket which are fixed in position, and thus may be used commonly in various vehicle models.

According to embodiments of the present disclosure, a mount device for a vehicle may be provided, which has a reduced manufacturing time and cost by eliminating the need for CNC machining.

According to embodiments of the present disclosure, a mount device for a vehicle may be provided, which does not require a separate tool during a manufacturing process and thus reduces a manufacturing time, while enabling mass production.

The effects that are achievable by the present disclosure are not limited to what has been particularly described hereinabove and other advantages not described herein will be more clearly understood by persons skilled in the art from the following description.

### BRIEF DESCRIPTION OF DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a perspective view illustrating a mount device for a vehicle according to an embodiment of the present disclosure;

FIG. 2 is an exploded perspective view of FIG. 1;

FIG. 3 is a diagram illustrating the mount device for a vehicle illustrated in FIG. 1 coupled to an electric component;

FIG. 4 is a diagram illustrating an example in which an electric component is installed on a bracket of a vehicle through a mount device for a vehicle according to the present disclosure;

FIG. 5 is a diagram illustrating a method for adjusting the length of a mount device for a vehicle according to an embodiment of the present disclosure;

FIG. 6 is a side view illustrating a mount device for a vehicle according to another embodiment of the present disclosure;

FIG. 7 is a perspective view illustrating a stopper illustrated in FIG. 6; and

FIG. 8 is a schematic diagram illustrating steps for manufacturing a conventional mount device for a vehicle.

### DETAILED DESCRIPTION

In the following description of examples or embodiments of the present disclosure, reference will be made to the accompanying drawings in which it is shown by way of illustration specific examples or embodiments that may be implemented, and in which the same reference numerals and signs may be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as "including", "having", "containing", "constituting" "make up of", and "formed of" used herein are generally intended to allow other components to be added unless the terms are used with the term "only". As used herein, singular forms are intended to include plural forms unless the context clearly indicates otherwise.

Terms, such as "first", "second", "A", "B", "(A)", or "(B)" may be used herein to describe elements of the present disclosure. Each of these terms is not used to define essence, order, sequence, or number of elements etc., but is used merely to distinguish the corresponding element from other elements.

When it is mentioned that a first element "is connected or coupled to", "contacts or overlaps" etc. a second element, it should be interpreted that, not only may the first element "be directly connected or coupled to" or "directly contact or overlap" the second element, but a third element may also be "interposed" between the first and second elements, or the first and second elements may "be connected or coupled to", "contact or overlap", etc. each other via a fourth element. Here, the second element may be included in at least one of two or more elements that "are connected or coupled to", "contact or overlap", etc. each other.

When time relative terms, such as "after," "subsequent to," "next," "before," and the like, are used to describe processes or operations of elements or configurations, or flows or steps in operating, processing, manufacturing methods, these terms may be used to describe non-consecutive or non-sequential processes or operations unless the term "directly" or "immediately" is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term "may" fully encompasses all the meanings of the term "can".

Various embodiments of the present disclosure will be described below in detail with reference to the accompanying drawings.

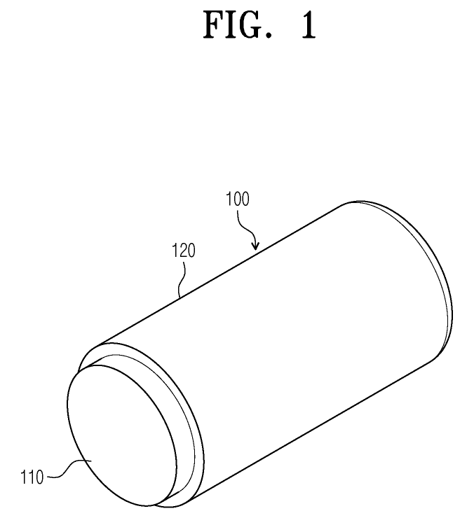

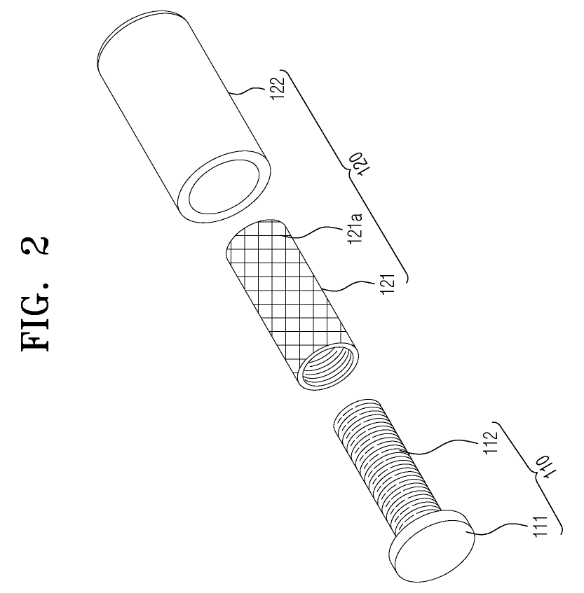

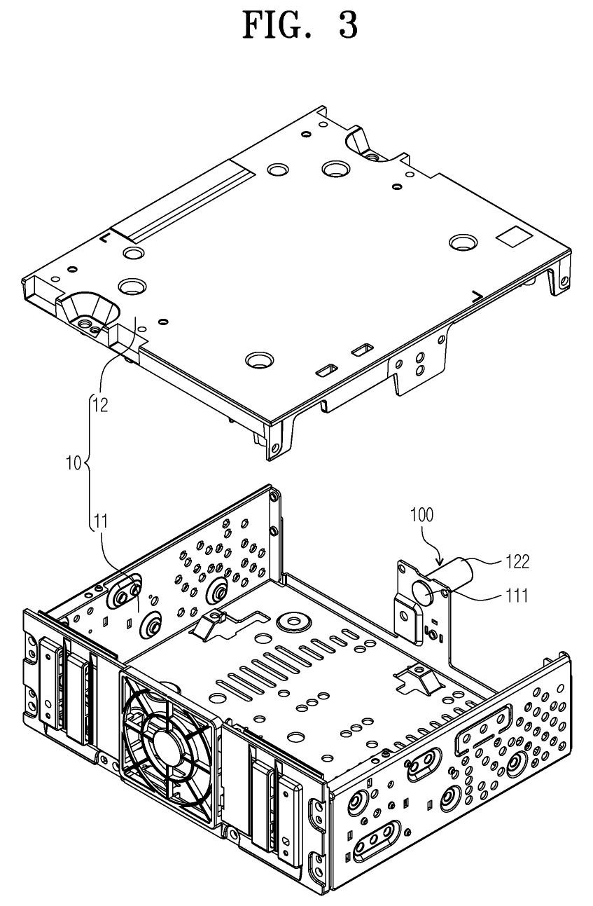

FIG. 1 is a perspective view illustrating a mount device for a vehicle according to an embodiment of the present disclosure, FIG. 2 is an exploded perspective view of FIGS. 1, and FIG. 3 is a diagram illustrating the mount device for a vehicle illustrated in FIG. 1 coupled to an electric component.

Referring to FIGS. 1 - 3, a mount device 100 for a vehicle is provided to fix the position of one side of an electric component 10 for a vehicle to a vehicle body, and may include a bolt member 110 and a nut member 120.

In this embodiment, the electric component 10 may be, but is not limited to, a vehicle controller with a processor, a memory, and a storage inside a housing 11, and may be applied to various electronic components such as an audio device, a video device, and audio video navigation (AVN).

The bolt member 110, which is fixed to the electric component 10, may have one side fixed to the electric component 10 and the other side protruding to the outside of the electric component 10. For example, the bolt member 110 may be formed of a metal material and include a head portion 111 and a shaft 112.

The head portion 111 may be formed in a circular or square plate shape, with one surface fixed to the electric component 10. For example, the surface of the head portion 111 may be fixed inside the housing 11 of the electric component 11 by welding.

The shaft 112 may protrude from one side of the head portion 111 to be located outside the electric component 10, and have a plurality of threads in a longitudinal direction on an outer circumferential surface thereof. For example, the electric component 10 may include the housing 11 having an accommodation space therein and a cover 12 covering the top of the housing 11. On one side of the housing 11, an installation hole may be formed in a size that allows the shaft 112 to pass through, but interferes with the head portion 111. Accordingly, the bolt member 110 may be securely fixed to the housing 11 by welding one surface of the head portion 111 to an inner side surface of the housing 11, with the shaft 112 passed through the installation hole inside the accommodation space of the housing 11.

The nut member 120 may be screw-coupled to the bolt member 110 and formed to linearly movable from the bolt member 110. For example, the nut member 120 may include a length adjustment portion 121 and a cover 122.

The length adjustment portion 121 may be formed of a metal material, and have threads on an inner circumferential surface thereof to be screw-coupled to the threads formed on the outer circumferential surface of the bolt member 110. For example, the length adjustment portion 121 may be formed in the shape of a cylinder with an open surface facing the bolt member 110 and a hollow hole therein. The length adjustment portion 121 may have a plurality of threads in a longitudinal direction on the inner circumferential surface thereof, to be meshed and screw-coupled to the threads formed on the outer circumferential surface of the shaft 112.

The cover 122, which is a component fixed in position on a bracket 20 formed within the vehicle body, for example, in a cockpit, may cover an outer circumferential surface of the length adjustment portion 121. For example, the length adjustment portion 121 and the cover 122 may be manufactured into a single body by an insert injection molding process. The method for combining the length adjustment portion 121 and the cover 122 is not limited to the above example, and they may be combined by various methods, such as forced fitting or bonding.

The cover 122 may be formed of a rubber material with a hardness of approximately 50 to 70. The formation of the cover 122 of a rubber material may both absorb vehicle vibrations and prevent friction noise from occurring between the mount device 100 and the bracket 20.

The length adjustment portion 121 may have a plurality of grooves 121a in a lattice pattern formed on the outer circumferential surface thereof. For example, a plurality of grooves may be formed in a lattice pattern on the outer circumferential surface of the length adjustment portion 121 through knurling. As the grooves 121a are formed on the outer circumferential surface of the length adjustment portion 121 in this way, frictional force with the cover 122 may be improved. Therefore, easy detachment of the cover 122 from the length adjustment portion 121 may be prevented.

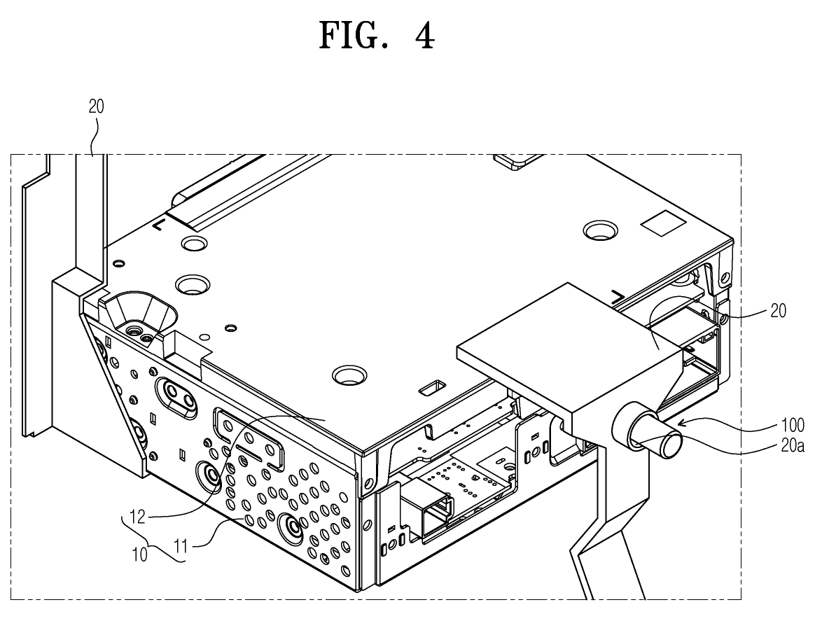

FIG. 4 is a diagram illustrating an example in which an electronic component is installed on a vehicle bracket through a mount device for a vehicle according to the present disclosure.

Referring to FIG. 4, the electronic component 10 may be fixed in position on the bracket 20 of the vehicle through the mount device 100 for a vehicle. For example, the front of the electronic component 10 may be fixed to the bracket 20 by bolting, and the rear thereof may be fixed in position within the vehicle by forming a portion of the mount device 100 coupled to the housing 11, to be inserted into and supported by a fixing hole 20a of the bracket 20. In other words, vibrations occurring during driving of the vehicle may be handled by bolting the front of the electronic component 10 to the bracket 20 and supporting the rear thereof by the bracket 20.

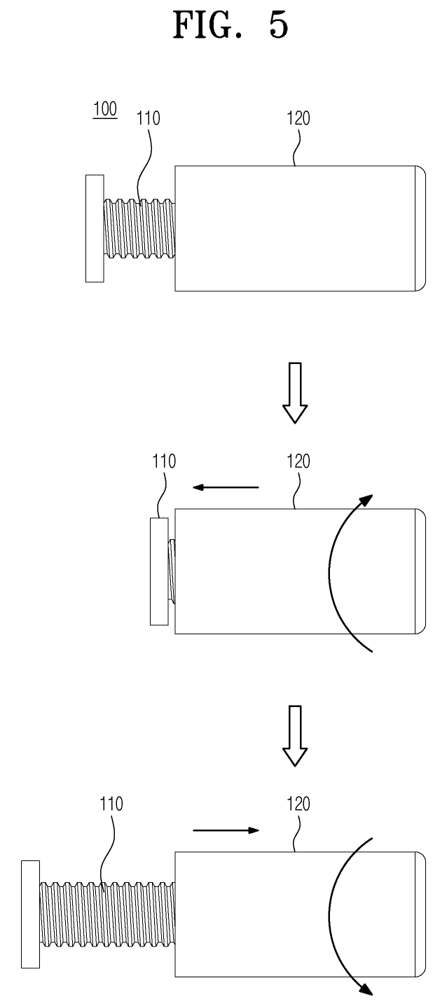

FIG. 5 is a diagram illustrating a method for adjusting the length of a mount device for a vehicle according to an embodiment of the present disclosure.

As illustrated in FIG. 5, when the nut member 120 is rotated clockwise or counter-clockwise, it moves linearly along the longitudinal direction of the bolt member 110, allowing the length of the mount device 100 to be changed.

For example, with the bolt member 110 fixed on the electronic component 10, grasping and rotating the nut member 120 clockwise causes the nut member 120 to move linearly toward the electronic component 10, thereby decreasing the overall length of the mount device 100.

Conversely, with the bolt member 110 fixed on the electronic component 10, grasping and rotating the nut member 120 counterclockwise causes the nut member 120 to move linearly away from the electronic component 10, thereby increasing the overall length of the mount device 100. This change in the length of the mount device 100 may increase or decrease proportionally to the amount of rotation of the nut member 120.

In this way, as the overall length of the mount device 100 is changed by the rotation of the nut member 120, the mount device 100 may be used for various vehicle types in common, adapting to changes in the internal structure of a vehicle. For example, the distance between the electronic component 10 and the bracket 20 may vary depending on the type and size of the vehicle. Since the length of the mount device 100 may be changed to match this distance, the mount device 100 may be used commonly across a wide range of vehicle types.

Additionally, since it is not necessary to replace the mount device with a different suitable one every time the distance between the electronic component 10 and the bracket 20 changes, the mount device may be used more conveniently.

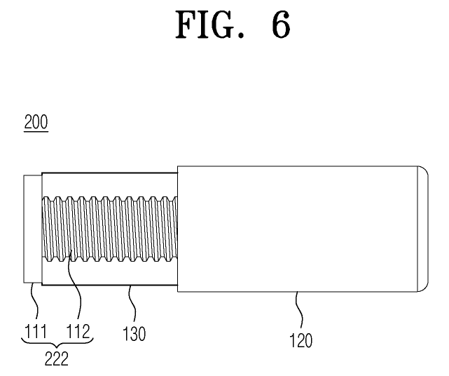

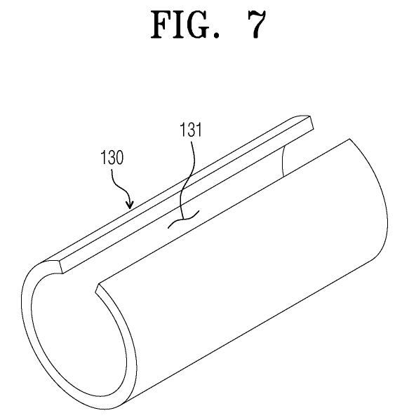

FIG. 6 is a side view illustrating a mount device for a vehicle according to another embodiment of the present disclosure, and FIG. 7 is a perspective view illustrating a stopper illustrated in FIG. 6. This embodiment will be described focusing on the differences from the foregoing embodiment.

Referring to FIGS. 6 and 7, a mount device 200 for a vehicle may further include a stopper 130 for presetting a fixed position of the nut member 120.

The stopper 130 may be formed to surround the outer circumferential surface of the shaft 112, with one side thereof in contact with the nut member 120 and the other side thereof in contact with the head portion 111.

The stopper 130 is intended to preset the fixed position of the nut member 120 according to the distance between the electronic component 10 to be installed and the bracket 20, and may be detachably coupled to the outer circumferential surface of the bolt member 110 before the mount device 100 is installed inside the vehicle. In other words, due to a narrow installation space inside the vehicle, it may be difficult to rotate the nut member 120 to match the distance between the electronic component 10 and the bracket 20 after the electronic component 10 is placed in the installation space. Therefore, as the stopper 130 formed in a length proportional to the distance between the electronic component 10 and the bracket 20 is provided, the fixed position of the nut member 120 may be preset before the mount device 100 is installed inside the vehicle.

The stopper 130 may have a slit 131 formed in a longitudinal direction on one side thereof, and may be elastically deformable through the slit 131. For example, the stopper 130 may be formed of a resin material such as plastic and elastically deformed by contracting or expanding through the slit 131 formed on the one side. As the stopper 130 is formed to be elastically deformable through the slit 131 in this way, it may be easily removed after the fixed position of the nut member 120 is set.

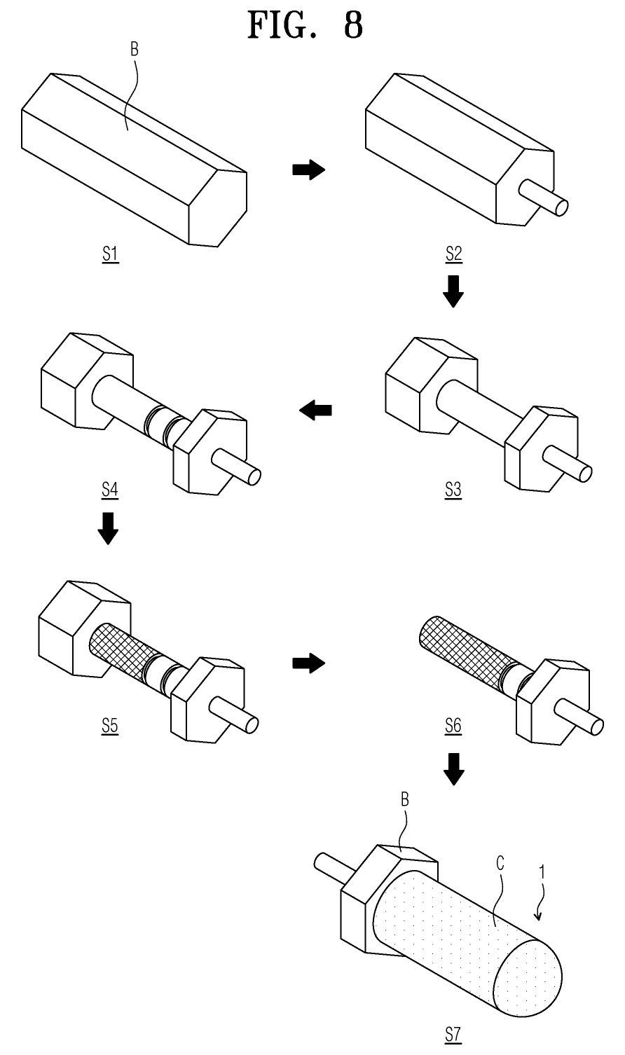

FIG. 8 is a schematic diagram illustrating steps for manufacturing a conventional mount device for a vehicle.

Referring to FIG. 8, a conventional mount device 1 for a vehicle may be formed through the process of: preparing a raw material metal bar B S1 ? tap processing S2 ? wick circular processing S3 ? groove shape processing S4 ? knurling S5 ? chamfer shape processing and cutting S6 ? insert injection molding S7 of the processed metal bar B and a rubber cover C. As such, the conventional mount device 1 has the problem of an increased manufacturing time and cost and difficulties in mass production due to complex processes such as CNC machining.

In contrast, the mount device 100 for a vehicle according to the present disclosure may omit CNC machining such as tap processing, groove shape processing, and chamfer shape processing, thereby reducing manufacturing costs.

Further, since the mount device 100 for a vehicle may be manufactured without a separate tool, a manufacturing time may be reduced and mass production may be made possible.

Additionally, because the mount device 100 for a vehicle is adjustable through screw-coupling between the bolt member 110 and the nut member 120, it is not necessary to have a plurality of mount devices of different lengths, which may reduce manufacturing costs. That is, conventionally, a different mount device 1 has to be manufactured and replaced every time the distance between the electronic component 10 and the bracket 20 changes. However, according to the present disclosure, a single type of mount device 100 for a vehicle may be used to adjust the length corresponding to the distance between the electronic component 10 and the bracket 20, thereby reducing manufacturing costs.

Further, since the length of the relatively high-cost metal bolt member 110 does not need to be increased, there is also an effect of reducing material costs.

The embodiments of the present disclosure described above are summarized as follows.

According to embodiments of the present disclosure, a mount device for a vehicle, for fixing a position of an electric component for the vehicle to a vehicle body, may be provided, including a bolt member having one side fixed to the electric component, and a nut member screw-coupled to the bolt member and formed to be linearly movable from the bolt member.

According to embodiments of the present disclosure, the bolt member may include a head portion fixed to the electric component, and a shaft protruding from one side of the head portion to be located outside the electric component, and having a thread formed on an outer circumferential surface thereof.

According to embodiments of the present disclosure, the nut member may include a length adjustment portion having a thread formed on an inner circumferential surface thereof to be screw-coupled to the thread formed on the outer circumferential surface of the bolt member, and a cover covering an outer circumferential surface of the length adjustment portion.

According to embodiments of the present disclosure, the length adjustment portion may have a plurality of grooves in a lattice pattern on the outer circumferential surface thereof.

According to embodiments of the present disclosure, the cover may be formed of a rubber material.

According to embodiments of the present disclosure, the length adjustment portion and the cover may be manufactured into a single body by an insert injection molding process.

According to embodiments of the present disclosure, the mount device for a vehicle may further include a stopper for presetting a fixed position of the nut member.

According to embodiments of the present disclosure, the stopper may be formed to surround the outer circumferential surface of the shaft, with one side thereof in contact with the nut member and the other side thereof in contact with the head portion.

According to embodiments of the present disclosure, the stopper may have a slit formed in a longitudinal direction on one side thereof and be elastically deformable through the slit.

According to embodiments of the present disclosure, when the nut member is rotated clockwise or counterclockwise, the nut member linearly may move along a longitudinal direction of the bolt member, and a length of the mount device may be changed.

According to embodiments of the present disclosure, a mount device for a vehicle, for fixing a position of an electric component for the vehicle to a vehicle body, may be provided, including a bolt member having one side fixed to the electric component, a nut member screw-coupled to the bolt member and formed to be linearly movable from the bolt member, and a stopper detachably coupled to the nut member to preset a fixed position of the nut member.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure.

What is claimed is:

1. A mount device for a vehicle, for fixing a position of an electric component for the vehicle to a vehicle body, comprising:
a bolt member having one side fixed to the electric component; and
a nut member screw-coupled to the bolt member and configured to be linearly movable from the bolt member.

2. The mount device for a vehicle according to claim 1, wherein the bolt member includes:
a head portion fixed to the electric component; and
a shaft protruding from one side of the head portion to extend outside the electric component, and having a thread formed on an outer circumferential surface thereof.

3. The mount device for a vehicle according to claim 2, wherein the nut member includes:
a length adjustment portion having a thread formed on an inner circumferential surface thereof and configured to be screw-coupled to the thread formed on the outer circumferential surface of the shaft of the bolt member; and
a cover covering an outer circumferential surface of the length adjustment portion.

4. The mount device for a vehicle according to claim 3, wherein the length adjustment portion has a plurality of grooves in a lattice pattern on the outer circumferential surface thereof.

5. The mount device for a vehicle according to claim 3, wherein the length adjustment portion and the cover are configured as a single body by an insert injection molding process.

6. The mount device for a vehicle according to claim 2, further comprising a stopper for presetting a fixed position of the nut member.

7. The mount device for a vehicle according to claim 6, wherein the stopper surrounds the outer circumferential surface of the shaft, with a first side of the stopper being in contact with the nut member and a second side of the stopper being in contact with the head portion.

8. The mount device for a vehicle according to claim 6, wherein the stopper has a slit disposed in a longitudinal direction on one side thereof and the stopper is elastically deformable through the slit.

9. The mount device for a vehicle according to claim 1, wherein when the nut member is rotated clockwise or counterclockwise, the nut member linearly moves along a longitudinal direction of the bolt member, and a length of the mount device is changed.

10. A mount device for a vehicle, for fixing a position of an electric component for the vehicle to a vehicle body, comprising:
a bolt member having one side fixed to the electric component;
a nut member screw-coupled to the bolt member and configured to be linearly movable from the bolt member; and
a stopper detachably coupled to the nut member to preset a fixed position of the nut member.
